(19) United States
(12) Patent Application Publication
(10) Pub. No.: US 2026/0010373 A1
(43) Pub. Date: Jan. 8, 2026

(54) MEMORY PREFETCH MECHANISM BASED ON INSTRUCTION SETS

(71) Applicant: QUALCOMM Incorporated, San Diego, CA (US)

(72) Inventors: Sachin KUMAR, Bangalore (IN); Saravana Raj SHANMUGAM, Bangalore (IN); Kaustubh SARWATE, Bangalore (IN)

(21) Appl. No.: 18/761,887

(22) Filed: Jul. 2, 2024

(51) Int. Cl. G06F 9/38; G06F 9/30

(52) U.S. Cl. CPC G06F 9/3814; G06F 9/30047; G06F 9/3005

(57) ABSTRACT

Aspects of the disclosure are directed to batch memory prefetching. In accordance with one aspect, the disclosure includes examining a current cache line from a plurality of cache lines; determining if a conditional branch opcode or an unconditional branch opcode is present; sending an anticipatory address to a bulk memory to fetch one or more anticipatory program instructions; and depositing the one or more anticipatory program instructions into a prefetch cache memory to augment an initial set of program instructions.

### TECHNICAL FIELD

This disclosure relates generally to the field of information processing systems, and to efficient memory prefetch schemes based on instruction sets.

### BACKGROUND

Information processing systems include a plurality of processors and a plurality of storage devices, for example, bulk memories. The plurality of storage devices may be organized as a memory hierarchy with multiple hierarchical levels. One type of memory in the memory hierarchy is a bulk memory where processor instructions may be retrieved directly but with a long latency. There is a need for direct retrieval of data and instructions from bulk memory with management of latency for improvement of overall system performance.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

In one aspect, the disclosure provides batch memory prefetching. Accordingly, the present disclosure discloses an apparatus including: an instruction sequencer configured to determine if a conditional branch opcode or an unconditional branch opcode is present and to anticipate a current prefetch buffer line based on a presence of the conditional branch opcode or the unconditional branch opcode; a prefetcher coupled to the instruction sequencer, the prefetcher configured to retrieve program instructions; and a prefetch buffer coupled to the prefetcher, the prefetch buffer configured to store the current prefetch buffer line.

In one example, the instruction sequencer is further configured to read a plurality of opcodes over a plurality of prefetch buffer lines. In one example, the apparatus further includes a bulk memory coupled to the prefetch buffer, the bulk memory configured to store the plurality of prefetch buffer lines. In one example, the instruction sequencer includes an opcode comparator configured to determine a presence of the conditional branch opcode or the unconditional branch opcode. In one example, the apparatus further includes a bulk memory controller coupled to the bulk memory, the bulk memory controller configured to manage read access and write access to the bulk memory. In one example, the apparatus further includes a serial interface coupled to the bulk memory controller and the bulk memory, the serial interface configured to allow the read access and the write access.

Another aspect of the disclosure provides an apparatus for implementing batch memory prefetching, the apparatus including: means for examining a current cache line from a plurality of cache lines; means for determining if a conditional branch opcode or an unconditional branch opcode is present; means for sending an anticipatory address to a bulk memory to fetch one or more anticipatory program instructions; and means for depositing the one or more anticipatory program instructions into a prefetch cache memory to augment an initial set of program instructions.

In one example, the apparatus further includes means for using a cache replacement policy for depositing the one or more anticipatory program instructions. In one example, the apparatus further includes: means for receiving the one or more anticipatory program instructions from the bulk memory; means for using a serial interface for receiving the one or more anticipatory program instructions; and means for placing the initial set of program instructions into the plurality of cache lines.

Another aspect of the disclosure provides a method including: examining a current cache line from a plurality of cache lines; determining if a conditional branch opcode or an unconditional branch opcode is present; sending an anticipatory address to a bulk memory to fetch one or more anticipatory program instructions; and depositing the one or more anticipatory program instructions into a prefetch cache memory to augment an initial set of program instructions.

In one example, the conditional branch opcode or the unconditional branch opcode is an operation code for defining an executable operation. In one example, the anticipatory address is a bulk memory address. In one example, the method further includes using a cache replacement policy for depositing the one or more anticipatory program instructions. In one example, the cache replacement policy uses one of the following: a sequential prefetching, a stride prefetching, a stream prefetching, a Markov prefetching, a demand-based prefetching, or a cache-line prefetching. In one example, the plurality of cache lines is in the prefetcher cache memory.

In one example, the method further includes receiving the one or more anticipatory program instructions from the bulk memory. In one example, the method further includes using a serial interface for receiving the one or more anticipatory program instructions. In one example, the serial interface is an octal serial peripheral interface (OSPI) or a quad serial peripheral interface (QSPI). In one example, the method further includes placing the initial set of program instructions into the plurality of cache lines. In one example, one of the conditional branch opcode or the unconditional branch opcode is part of a program instruction within the current cache line.

These and other aspects of the present disclosure will become more fully understood upon a review of the detailed description, which follows. Other aspects, features, and implementations of the present disclosure will become apparent to those of ordinary skill in the art, upon reviewing the following description of specific, exemplary implementations of the present invention in conjunction with the accompanying figures. While features of the present invention may be discussed relative to certain implementations and figures below, all implementations of the present invention can include one or more of the advantageous features discussed herein. In other words, while one or more implementations may be discussed as having certain advantageous features, one or more of such features may also be used in accordance with the various implementations of the invention discussed herein. In similar fashion, while exemplary implementations may be discussed below as device, system, or method implementations it should be understood that such exemplary implementations can be implemented in various devices, systems, and methods.

### BRIEF DESCRIPTION OF THE DRAWINGS

FIG. 1 illustrates an example information processing system.

FIG. 2 illustrates an example coupled prefetcher and instruction sequencer architecture.

FIG. 3 illustrates an example sequence diagram of a coupled prefetcher and instruction sequencer.

FIG. 4 illustrates an example flow diagram for implementing batch memory prefetching.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

While for purposes of simplicity of explanation, the methodologies are shown and described as a series of acts, it is to be understood and appreciated that the methodologies are not limited by the order of acts, as some acts may, in accordance with one or more aspects, occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with one or more aspects.

An information processing system, for example, a computing system with multiple slices (e.g., processing engines) or a system on a chip (SoC), may require multiple levels of coordination or synchronization. In one example, a slice may include a processing engine (i.e., a subset of the computing system) as well as associated memory units and other peripheral devices. In one example, execution of an application may be decomposed into a plurality of work tasks which are executed by multiple slices or multiple processing engines.

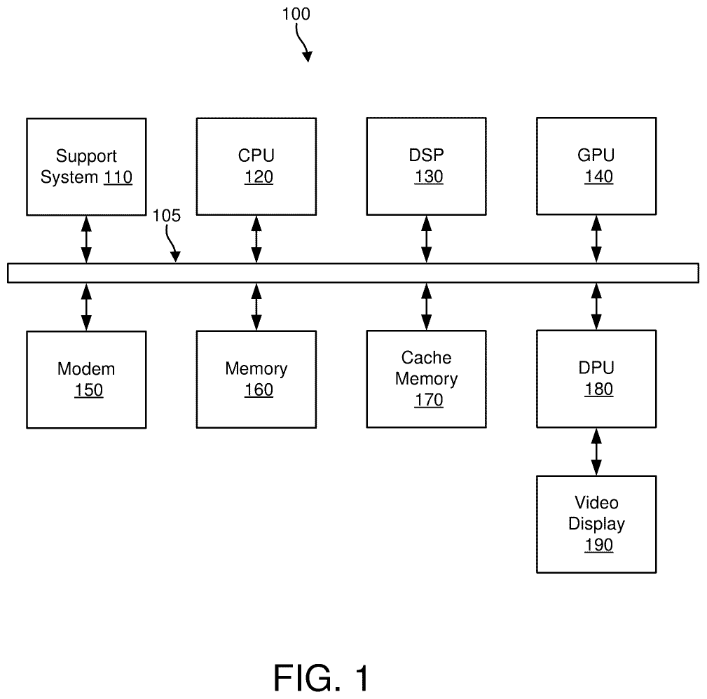

FIG. 1 illustrates an example information processing system 100. In one example, the information processing system 100 includes a plurality of processing engines such as a central processing unit (CPU) 120, a digital signal processor (DSP) 130, a graphics processing unit (GPU) 140, a display processing unit (DPU) 180, etc. In one example, various other functions in the information processing system 100 may be included such as a support system 110, a modem 150, a memory 160, a cache memory 170 and a video display 190. For example, the plurality of processing engines and various other functions may be interconnected by an interconnection databus 105 to transport data and control information.

For example, the memory 160 and/or the cache memory 170 may be shared among the CPU 120, the GPU 140s and the other processing engines. In one example, the CPU 120 may include a first internal memory which is not shared with the other processing engines. In one example, the GPU 140 may include a second internal memory which is not shared with the other processing engines. In one example, any processing engine of the plurality of processing engines may have an internal memory (i.e., a dedicated memory) which is not shared with the other processing engines. Although several components of the information processing system 100 are included herein, one skilled in the art would understand that the components listed herein are examples and are not exclusive. Thus, other components may be included as part of the information processing system 100 within the spirit and scope of the present disclosure.

In one example, the information processing system 100 may be part of a wireless device in a wireless communication system. For example, the wireless communication system may conform to a wireless network protocol such as 4G LTE (long term evolution), 5G NR (new radio), etc.

In one example, an information processing system may have a memory hierarchy with different levels of memory access times and storage capacity. In one example, a memory with larger storage capacity has a slower memory access time and a memory with smaller storage capacity has a faster memory access time. In one example, a bulk memory is a memory device with large storage capacity but slow memory access time which may be more suitable for bulk storage applications. In one example, memory access time for bulk memory may be independent of its storage capacity and is governed by its interface details. In one example, a local memory is a memory device with small storage capacity but fast memory access time which may be more suitable for immediate processing applications.

One type of memory with relatively large storage capacity is a flash memory. Another type of memory with relatively large storage capacity is a pseudostatic random access memory (PSRAM). For example, a PSRAM is a type of dynamic RAM with internal refresh capability. In one example, both flash memory and PSRAM have relatively slow memory access time and their usage may result in a processor stall (i.e., a period of time where a processor is waiting for memory access either for reading, writing or for fetching instructions for execution). That is, flash memory and PSRAM may be considered as bulk memory. In one example, bulk memory may connect to the processor with a serial interface, such as Quad peripheral Serial Interface (QPSI), Octal Peripheral Serial Interface (OSPI) or Host Port Interface (HPI). In one example, bulk memory may include a long latency path. In one example, cache memory may be considered as local memory.

In one example, prefetching is a commonly used technique in an information processing system where program instructions to be executed by a processor are retrieved from bulk memory (e.g., flash memory) and placed into local memory (e.g., cache memory) ahead of their need. In one example, prefetching is performed to minimize processor execution latency. One example of prefetching is prefetching program instructions from bulk memory, for example, execute in place (XIP). In one example, prefetching program instructions from bulk memory may add excessive latency toward processor execution (e.g., a latency of approximately 50 clock cycles). Excessive latency may lead to a processor stall.

In one example, prefetching program instructions from a bulk memory has used a plurality of prefetching techniques such as sequential prefetching, stride prefetching, stream prefetching, Markov prefetching, demand-based prefetching, cache-line prefetching, etc. In one example, the plurality of prefetching techniques has relied on mathematical modeling of memory access patterns. However, in one example, the plurality of prefetching techniques has not employed instruction-based prefetching. In one example, the overall goal of prefetching is a reduction of latency or delay in processing.

In one example, performance of a prefetching technique is determined by a hit ratio, that is number of prefetched program instructions that are actually executed over the number of total prefetched program instructions. In one example, improved prefetching performance, that is, a higher hit ratio, may be attained by coupling an instruction sequencer with a prefetcher to regulate processor accesses to bulk memory.

In one example, the instruction sequencer retrieves a plurality of cache lines from a bulk memory and stores the plurality of cache lines in a cache memory. In one example, the plurality of cache lines may be prefetch lines, that is, cache lines which are prefetched. In one example, the plurality of prefetch lines includes a plurality of program instructions. For example, the instruction sequencer may continuously monitor and read program instructions on each prefetch line and decode branch instructions. In one example, the instruction sequencer stores prefetch lines with program instructions for positive branch addresses and negative branch addresses. For example, the prefetching may allow program instructions from bulk memory (e.g., flash memory) to be available on the prefetch lines. In one example, prefetching is coupled with a cache replacement policy (i.e., deciding when to update cache memory) for improved prefetching efficiency.

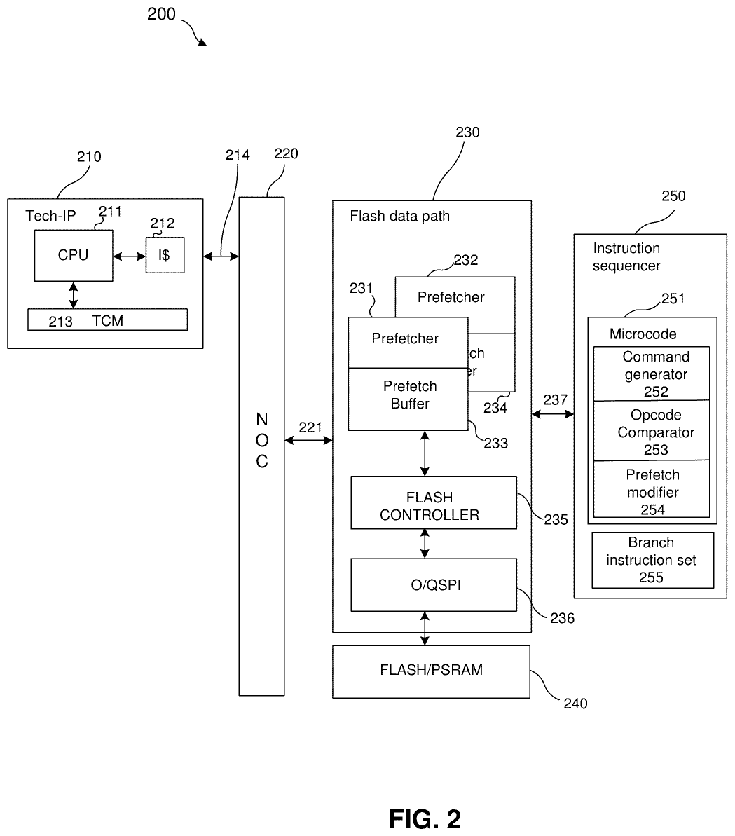

FIG. 2 illustrates an example coupled prefetcher and instruction sequencer architecture 200. In one example, the coupled prefetcher and instruction sequencer architecture 200 includes a host processor subsystem 210 which includes a central processor unit (CPU) 211, an instruction cache memory 212 and a local memory 213 (e.g., tightly coupled memory (TCM)). In one example, the CPU 211 retrieves program instructions from the instruction cache memory 212 and retrieves and stores data in the local memory 213. In one example, the coupled prefetcher and instruction sequencer architecture 200 further includes network on a chip (NOC) 220, bulk memory access subsystem 230, a bulk memory 240 and an instruction sequencer 250.

In one example, the host processor subsystem 210 is coupled to a network on a chip (NOC) 220 via a processor-NOC interface 214. In one example, the NOC 220 provides packet-based interconnection among a plurality of network nodes (e.g., processors, memories, registers, etc.). In one example, the NOC 220 is coupled to a bulk memory access subsystem 230 via a NOC-bulk memory access interface 221.

In one example, the bulk memory access subsystem 230 includes a first prefetcher 231 with a first prefetch buffer 233, a second prefetcher 232 with a second prefetch buffer 234, a bulk memory controller 235 (which may also be a flash controller or a PSRAM controller), and a serial interface 236 (e.g., octal peripheral serial interface/quad peripheral serial interface (OPSI/QPSI)). For example, the serial interface 236 may serve as a memory interface to a bulk memory 240. In one example, the bulk memory 240 is a flash memory. In one example, the bulk memory 240 is a PSRAM. In one example, the bulk memory controller 235 manages read/write access to the bulk memory 240. In one example, the first prefetcher 233 and the second prefetcher 232 may each be dedicated to a separate processor to maintain cache coherency. In one example, each instruction opcodes for branching for each processor may be different such that each prefetcher requires a processor identifier. In one example, the processor identifier may be transported over NOC 220 to a respective prefetcher.

In one example, the bulk memory access subsystem 230 is coupled to an instruction sequencer 250 via a bulk memory access-instruction sequencer interface 237. As an example, the instruction sequencer 250 includes a microcode module 251 with a command generator 252, an opcode comparator 253 and a prefetch modifier 254. In one example, the instruction sequencer 250 also includes a branch instruction set module 255. In one example, an opcode is an operation code to define an executable operation (e.g., add, subtract, increment, decrement, write, read, etc.). In one example, the command generator is used for generating commands associated with the instruction sequencer 250. In one example, the prefetch modifier 254 is configured to modify prefetch buffer lines.

In one example, the instruction sequencer 250 continuously monitors a current prefetch buffer line in the first prefetch buffer 233 and the second prefetch buffer 234 being accessed by the CPU 211. For example, the instruction sequencer 250 may anticipate the current prefetch buffer line and reads a plurality of opcodes over a plurality of prefetch buffer lines. That is, anticipate the current prefetch buffer line refers to using the current prefetch buffer line to fetch other program instructions prior to processor need. In one example, if one opcode of the plurality of opcodes matches any branch instruction type, a plurality of anticipatory prefetch buffer lines is populated based on the matched branch instruction type. In one example, line replacement in the first prefetch buffer 233 or the second prefetch buffer 234 may be executed by a combination of anticipatory prefetching and a cache replacement policy. In one example, anticipatory prefetching refers to fetching program instructions from bulk memory prior to processor need (i.e., program instructions that are anticipated to be used in the future).

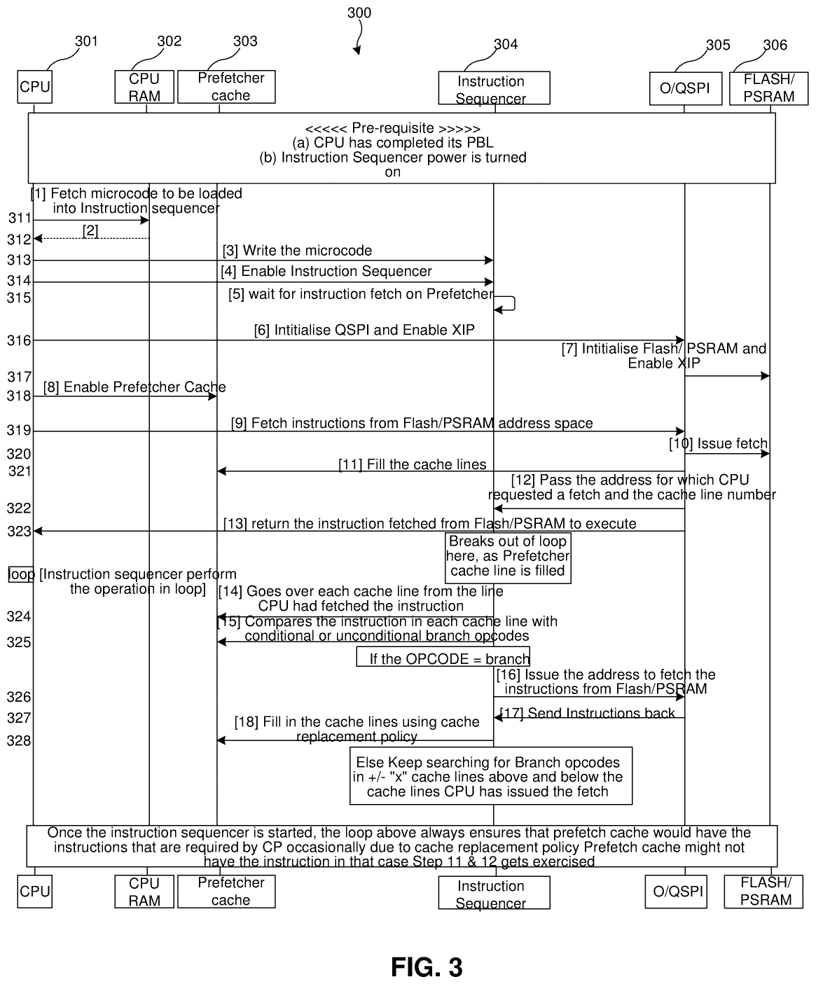

FIG. 3 illustrates an example sequence diagram 300 of a coupled prefetcher and instruction sequencer. In one example, the sequence diagram includes a CPU 301, a CPU memory (e.g., RAM) 302, a prefetcher cache memory 303, an instruction sequencer 304, a serial interface (e.g., OSPI/QSPI) 305 and a bulk memory (e.g., flash memory or PSRAM) 306.

In one example, a prerequisite action 310 in the sequence diagram includes confirming the CPU 301 has completed its preboot loader (PBL) and the instruction sequencer 304 has been powered on. In one example, a first action 311 includes the CPU 301 requesting a fetch of a microcode to be loaded into the instruction sequencer 304 from the CPU memory 302. In one example, a second action 312 includes the CPU memory 302 sending the microcode to the CPU 301. In one example, a third action 313 includes the CPU 301 writing the microcode into the instruction sequencer 304. In one example, a fourth action 314 includes the CPU 301 sending an instruction sequencer enable directive to the instruction sequencer 304. In one example, a fifth action 315 includes the instruction sequencer 304 waiting for an instruction fetch by a prefetcher.

In one example, a sixth action 316 includes the CPU 301 initializing the serial interface 305 and enabling an execute in place (XIP) functionality. In one example, a seventh action 317 includes the serial interface 305 initializing the bulk memory 306 and enabling XIP for the bulk memory 306. In one example, an eighth action 318 includes the CPU 301 enabling the prefetcher cache memory 303. In one example, a ninth action 319 includes the CPU 301 fetching desired program instructions from the bulk memory 306 access space with a fetch address using the serial interface 305. In one example, a tenth action 320 includes the serial interface 305 issuing a fetch directive to the bulk memory 306.

In one example, an eleventh action 321 includes the bulk memory 306 loading a plurality of cache lines using the serial interface 305 into the prefetcher cache memory 303. In one example, a twelfth action 322 includes the serial interface 305 sending the fetch address and a cache line number to the instruction sequencer 304. In one example, the twelfth action 322 includes a trigger signal to the instruction sequencer 304 to indicate a memory fetch. In one example, a thirteenth action 323 includes the serial interface 305 returning the desired fetch instructions from the bulk memory 306 to the CPU 301.

In one example, a fourteenth action 324 includes the instruction sequencer 304 examining a current cache line of the plurality of cache lines in the prefetcher cache memory 303. In one example, the examination of the current cache line searches for a match with the desired fetch instructions and sending the current cache line to the CPU 301. In one example, a fifteenth action 325 includes the instruction sequencer 304 comparing a program instruction in the current cache line with conditional or unconditional branch opcodes. In one example, the comparison also includes determining a destination address of the conditional or unconditional branch opcodes. In one example, a sixteenth action 326 includes the instruction sequencer 304 sending an address to the serial interface 305 to fetch program instructions from bulk memory 306 if the program instruction in the current cache line includes a conditional or unconditional branch opcode.

In one example, a seventeenth action 327 includes sending the program instructions from bulk memory 306 through the serial interface 305 to the instruction sequencer 304. In one example, an eighteenth action 328 includes the instruction sequencer 304 loading a plurality of cache lines with the program instructions with a conditional or unconditional branch opcode. In one example, the loading of cache lines is performed in conformance with a cache replacement policy.

In one example, after examining adjacent cache lines relative to the current cache line, a loop is executed repeatedly starting from the fourteenth action 324 while searching for conditional or unconditional branch opcodes. In one example, adjacent cache lines are referenced with a positive offset or a negative offset from the current cache line.

In one example, once the instruction sequencer 304 has started operation, the loop starting in the fourteenth action 324 ensures that the prefetch cache memory 303 has program instructions required by the CPU 301. In one example, on occasion, the prefetch cache memory 303 may not have the required program instructions due to execution of a cache replacement policy. In one example, the eleventh action 321 and the twelfth action 322 are exercised to retrieve the required program instructions.

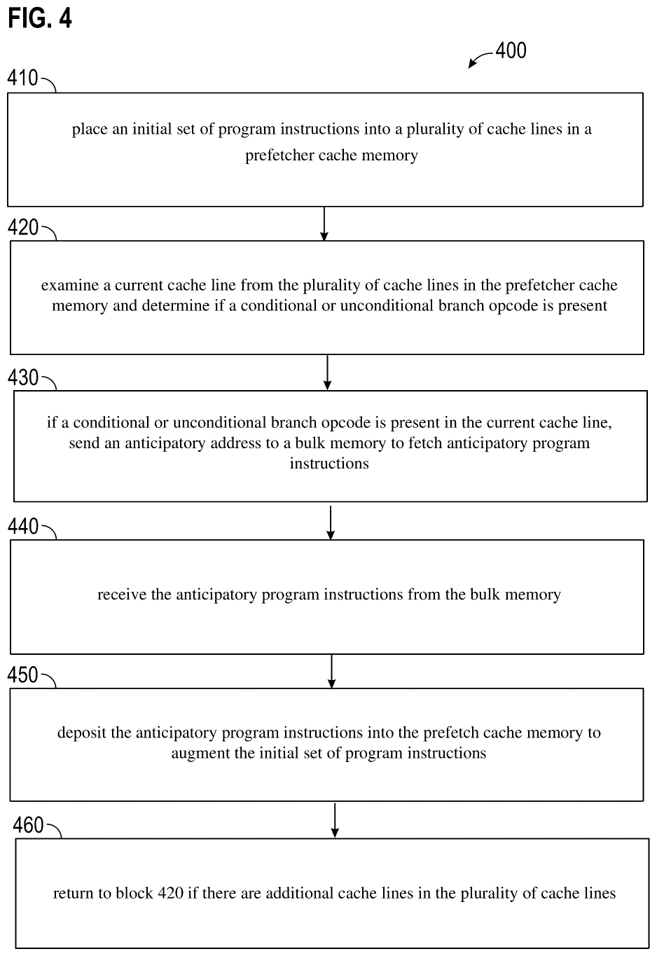

FIG. 4 illustrates an example flow diagram 400 for implementing batch memory prefetching. In one example, the batch memory prefetching uses a coupled prefetcher and instruction sequencer. In block 410, place an initial set of program instructions into a plurality of cache lines in a prefetcher cache memory. In one example, an initial set of program instructions is placed into a plurality of cache lines in a prefetcher cache memory.

In one example, the placement follows a fetch directive with a fetch address from the processor. In one example, the fetch occurs subsequent to enabling execute in place (XIP) for the bulk memory. In one example, a cache line of the plurality of cache lines is an addressable element of the prefetcher cache memory. In one example, the bulk memory is flash memory. In one example, the bulk memory is pseudo static random access memory (PSRAM). In one example, the placement is performed by the bulk memory.

In block 420, examine a current cache line from the plurality of cache lines in the prefetcher cache memory and determine if a conditional branch opcode or an unconditional branch opcode is present. In one example, a current cache line from the plurality of cache lines in the prefetcher cache memory is examined and a determination is made to see if a conditional branch opcode or an unconditional branch opcode is present.

In one example, the conditional branch opcode or the unconditional branch opcode is part of a program instruction within the current cache line. In one example, an opcode is an operation code to define an executable operation for the program instruction. In one example, the examination and/or determination is performed by an instruction sequencer. In one example, an opcode comparator examines the current cache line. In one example, the opcode comparator determines the presence of the conditional branch opcode or the unconditional branch opcode. In one example, the opcode comparator is a component within the instruction sequencer.

In block 430, if a conditional branch opcode or an unconditional branch opcode is present in the current cache line, send an anticipatory address to a bulk memory to fetch anticipatory program instructions. In one example, if a conditional branch opcode or an unconditional branch opcode is present in the current cache line, an anticipatory address is sent to a bulk memory to fetch anticipatory program instructions. In one example, the anticipatory address is a bulk memory address of a program instruction which is fetched prior to processor need (i.e., program instructions that are anticipated to be used in the future). In one example, the sending is performed by the instruction sequencer.

In block 440, receive the anticipatory program instructions from the bulk memory. In one example, the anticipatory program instructions are received from the bulk memory. In one example, the receiving uses a serial interface. In one example, the serial interface is an octal serial peripheral interface (OSPI) or a quad serial peripheral interface (QSPI). In one example, the receiving is performed by the instruction sequencer.

In block 450, deposit the anticipatory program instructions into the prefetch cache memory to augment the initial set of program instructions. In one example, the anticipatory program instructions are deposited into the prefetch cache memory to augment the initial set of program instructions. In one example, the depositing may use a cache replacement policy. In one example, the cache replacement policy is used when the prefetch cache memory is filled. In one example filling of the prefetch cache memory is based on branch opcodes In one example, the cache replacement policy may use sequential prefetching, stride prefetching, stream prefetching, Markov prefetching, demand-based prefetching, or cache-line prefetching. In one example, the depositing is performed by the instruction sequencer.

In block 460, return to block 420 if there are additional cache lines in the plurality of cache lines. In one example, if there are additional cache lines in the plurality of cache lines, return to block 420 and perform the step in block 420 and follow along the steps in blocks 430-450.

In one aspect, one or more of the steps for providing batch memory prefetching in FIG. 4 may be executed by one or more processors which may include hardware, software, firmware, etc. The one or more processors, for example, may be used to execute software or firmware needed to perform the steps in the flow diagram of FIG. 4. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The software may reside on a computer-readable medium. The computer-readable medium may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium may also include, by way of example, a carrier wave, a transmission line, and any other suitable medium for transmitting software and/or instructions that may be accessed and read by a computer. The computer-readable medium may reside in a processing system, external to the processing system, or distributed across multiple entities including the processing system. The computer-readable medium may be embodied in a computer program product. By way of example, a computer program product may include a computer-readable medium in packaging materials. The computer-readable medium may include software or firmware. Those skilled in the art will recognize how best to implement the described functionality presented throughout this disclosure depending on the particular application and the overall design constraints imposed on the overall system.

Any circuitry included in the processor(s) is merely provided as an example, and other means for carrying out the described functions may be included within various aspects of the present disclosure, including but not limited to the instructions stored in the computer-readable medium, or any other suitable apparatus or means described herein, and utilizing, for example, the processes and/or algorithms described herein in relation to the example flow diagram.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

One or more of the components, steps, features and/or functions illustrated in the figures may be rearranged and/or combined into a single component, step, feature or function or embodied in several components, steps, or functions. Additional elements, components, steps, and/or functions may also be added without departing from novel features disclosed herein. The apparatus, devices, and/or components illustrated in the figures may be configured to perform one or more of the methods, features, or steps described herein. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the principles defined herein may be applied to other aspects. Thus, the claims are not intended to be limited to the aspects shown herein, but are to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

One skilled in the art would understand that various features of different embodiments may be combined or modified and still be within the spirit and scope of the present disclosure.

What is claimed is:

1. An apparatus comprising:
an instruction sequencer configured to determine if a conditional branch opcode or an unconditional branch opcode is present and to anticipate a current prefetch buffer line based on a presence of the conditional branch opcode or the unconditional branch opcode;
a prefetcher coupled to the instruction sequencer, the prefetcher configured to retrieve program instructions; and
a prefetch buffer coupled to the prefetcher, the prefetch buffer configured to store the current prefetch buffer line.

2. The apparatus of claim 1, wherein the instruction sequencer is further configured to read a plurality of opcodes over a plurality of prefetch buffer lines.

3. The apparatus of claim 2, further comprising a bulk memory coupled to the prefetch buffer, the bulk memory configured to store the plurality of prefetch buffer lines.

4. The apparatus of claim 3, wherein the instruction sequencer includes an opcode comparator configured to determine a presence of the conditional branch opcode or the unconditional branch opcode.

5. The apparatus of claim 3, further comprising a bulk memory controller coupled to the bulk memory, the bulk memory controller configured to manage read access and write access to the bulk memory.

6. The apparatus of claim 5, further comprising a serial interface coupled to the bulk memory controller and the bulk memory, the serial interface configured to allow the read access and the write access.

7. An apparatus for implementing batch memory prefetching, the apparatus comprising:
means for examining a current cache line from a plurality of cache lines;
means for determining if a conditional branch opcode or an unconditional branch opcode is present;
means for sending an anticipatory address to a bulk memory to fetch one or more anticipatory program instructions; and
means for depositing the one or more anticipatory program instructions into a prefetch cache memory to augment an initial set of program instructions.

8. The apparatus of claim 7, further comprising means for using a cache replacement policy for depositing the one or more anticipatory program instructions.

9. The apparatus of claim 8, further comprising:
means for receiving the one or more anticipatory program instructions from the bulk memory;
means for using a serial interface for receiving the one or more anticipatory program instructions; and
means for placing the initial set of program instructions into the plurality of cache lines.

10. A method comprising:
examining a current cache line from a plurality of cache lines;
determining if a conditional branch opcode or an unconditional branch opcode is present;
sending an anticipatory address to a bulk memory to fetch one or more anticipatory program instructions; and
depositing the one or more anticipatory program instructions into a prefetch cache memory to augment an initial set of program instructions.

11. The method of claim 10, wherein the conditional branch opcode or the unconditional branch opcode is an operation code for defining an executable operation.

12. The method of claim 10, wherein the anticipatory address is a bulk memory address.

13. The method of claim 10, further comprising using a cache replacement policy for depositing the one or more anticipatory program instructions.

14. The method of claim 13, wherein the cache replacement policy uses one of the following: a sequential prefetching, a stride prefetching, a stream prefetching, a Markov prefetching, a demand-based prefetching, or a cache-line prefetching.

15. The method of claim 10, wherein the plurality of cache lines is in the prefetcher cache memory.

16. The method of claim 15, further comprising receiving the one or more anticipatory program instructions from the bulk memory.

17. The method of claim 16, further comprising using a serial interface for receiving the one or more anticipatory program instructions.

18. The method of claim 17, wherein the serial interface is an octal serial peripheral interface (OSPI) or a quad serial peripheral interface (QSPI).

19. The method of claim 15, further comprising placing the initial set of program instructions into the plurality of cache lines.

20. The method of claim 19, wherein one of the conditional branch opcode or the unconditional branch opcode is part of a program instruction within the current cache line.
